(19) United States
(12) Patent Application Publication
(10) Pub. No.: US 2021/0245238 A1
(43) Pub. Date: Aug. 12, 2021

(54) MOLDING TOOL WITH HIGH-PERFORMANCE COOLING SYSTEM

(71) Applicant: GROUPER CASTING, LLC, Lexington, KY (US)

(72) Inventors: Stephen Fetsko, Medina, OH (US); Erik Leaske, Northville, MI (US)

(21) Appl. No.: 17/270,572

(22) PCT Filed: Aug. 21, 2019
(86) PCT No.: PCT/US2019/047525

§ 371 Date: Feb. 23, 2021

Related U.S. Application Data
(60) Provisional application No. 62/722,496, filed on Aug. 24, 2018.

(51) Int. Cl. B22C 9/06; C09K 5/12

(52) U.S. Cl. CPC B22C 9/065; C09K 5/12

(57) ABSTRACT

A cooling system for a molding tool or molding machine includes a high-performance coolant, multiple cooling circuits with different coolants flowing along each circuit, and/or a self-contained cooling circuit. The high-performance coolant can include a metallic component in various forms, including a liquid phase metal form. Newly recognized coolant characteristics such as volumetric heat capacity (Cᵥ) can be used to identify suitable coolants. High-performance coolants can be used to reduce molding process cycle times, to spatially equalize the cooling rate of the molding material among different sections of the mold cavity, and/or to help cool other parts of the tool or machine such as a runner or an injection sleeve.

### FIELD

The present disclosure relates to molding tools and, more particularly, to cooling systems and methods of solidifying molten molding material during molding processes.

### BACKGROUND

As a manufacturing process, molding involves filling a mold cavity with a molten material and subsequently solidifying the material so that it takes the shape of the mold cavity before being removed from the mold. The time required to cool the molten material in the mold cavity can be a bottleneck in the manufacturing process, as it is usually greater than the time required to open, close, or fill the mold. In some molding processes, such as metal die casting, the molten material can be at a temperature high enough to cause water-based coolants to vaporize. Non-aqueous coolants are few and usually involve a sacrifice of some of the characteristics that make water-based coolants attractive.

### SUMMARY

In accordance with various embodiments, a molding tool includes a cooling system in which a coolant flows along a fluid channel formed within a body of the molding tool. The coolant comprises a liquid phase metal.

In various embodiments, the molding tool includes a self-contained cooling circuit comprising a pump, the fluid channel, and the coolant. The cooling circuit is integrated with the body of the molding tool so that the cooling circuit remains part of the molding tool when the molding tool is installed in a molding machine and when the molding tool is uninstalled from the molding machine.

In various embodiments, the liquid phase metal includes a eutectic alloy comprising a plurality of different metallic elements.

In various embodiments, the liquid phase metal comprises gallium.

In various embodiments, the molding tool includes first and second tool portions and a runner that interconnects a mold cavity with a molding material source when the molding tool is installed in a molding machine. The first and second tool portions at least partly define the mold cavity when the molding tool is in a closed condition. The fluid channel is one of a plurality of fluid channels formed within the body of the molding tool and is the closest of the fluid channels to the runner.

In various embodiments, the fluid channel is part of a cooling circuit along which the coolant flows through a heat extraction zone and a heat sink region. The coolant extracts heat from a molding material in a mold cavity of the molding tool in the heat extraction zone while heat is extracted from the coolant in the heat sink region. The heat sink region is formed within the body of the molding tool.

In accordance with various embodiments, a molding tool includes a self-contained cooling circuit that includes a pump, a fluid channel, and a coolant. The cooling circuit is integrated with a body of the molding tool so that the cooling circuit remains part of the molding tool when the molding tool is installed in a molding machine and when the molding tool is uninstalled from the molding machine.

In various embodiments, the molding tool includes an additional cooling circuit distinct from the self-contained cooling circuit. The additional cooling circuit contains a coolant different from the coolant of the self-contained cooling circuit.

In various embodiments, the coolant of the self-contained cooling circuit includes a eutectic alloy comprising a plurality of different metallic elements.

In various embodiments, the coolant of the self-contained cooling circuit includes gallium.

In various embodiments, the molding tool includes first and second tool portions and a runner that interconnects a mold cavity with a molding material source when the molding tool is installed in the molding machine. The first and second tool portions at least partly define the mold cavity when the molding tool is in a closed condition. The fluid channel is one of a plurality of fluid channels of the self-contained cooling circuit and is the closest of the fluid channels to the runner.

In various embodiments, the coolant flows along the self-contained cooling circuit through a heat extraction zone and a heat sink region. The coolant extracts heat from a molding material in a mold cavity of the molding tool in the heat extraction zone while heat is extracted from the coolant in the heat sink region. The heat sink region is formed within the body of the molding tool.

In accordance with various embodiments, a molding tool includes a cooling system that includes a first cooling circuit and a second cooling circuit distinct from the first cooling circuit. Each cooling circuit contains a different coolant, and at least one of the coolants has a thermal conductivity of 1.0 W/m-K or greater.

In various embodiments, at least one of the cooling circuits is a self-contained cooling circuit comprising a pump, a fluid channel, and a liquid phase metal coolant. The self-contained cooling circuit is integrated with a body of the molding tool and remains part of the molding tool when the molding tool is installed in a molding machine and when the molding tool is uninstalled from the molding machine.

In various embodiments, at least one of the different coolants includes a eutectic alloy that includes a plurality of different metallic elements.

In various embodiments, at least one of the different coolants includes gallium.

In various embodiments, the molding tool includes first and second tool portions and a runner that interconnects a mold cavity with a molding material source when the molding tool is installed in a molding machine. The first and second tool portions at least partly define the mold cavity when the molding tool is in a closed condition. The coolant contained by the cooling circuit closest to the runner has the highest thermal conductivity of the different coolants.

In various embodiments, a first coolant flows along the first cooling circuit and a second coolant flows along the second cooling circuit. The first coolant extracts heat from a molding material in a mold cavity of the molding tool at a first portion of the first cooling circuit, and the second coolant extracts heat from the first coolant at a second portion of the first cooling circuit formed within a body of the molding tool.

In accordance with various embodiments, a molding machine is configured for installation and removal of a molding tool. The molding machine includes a self-contained cooling circuit including a pump, a fluid channel, and a high-performance coolant. The cooling circuit is integrated with the molding machine so that the cooling circuit remains part of the molding machine when the molding tool is removed from the molding machine.

In various embodiments, the fluid channel is located along an injection system sleeve from which molten molding material is injected into a cavity of the molding tool when installed in the molding machine.

It is envisioned that any of the above features can be combined with any other one or more of the above features or with any of the features described below or illustrated in the drawings, except where there is an incompatibility of features.

### DRAWINGS

FIG. 1 is a schematic cross-sectional view of a molding tool equipped with a cooling system having a cooling circuit containing a coolant comprising a metal;

FIG. 2 is a schematic cross-sectional view of the molding tool of FIG. 1 equipped with a cooling system having first and second cooling circuits, each containing a different coolant;

FIG. 3 is a schematic cross-sectional view of the molding tool of FIGS. 1 and 2 equipped with a cooling system having a self-contained cooling circuit; and

FIG. 4 is schematic cross-sectional view of the molding tool of FIGS. 1-3 equipped with a cooling system having first and second cooling circuits, each containing a different coolant and one of which is self-contained.

### DESCRIPTION

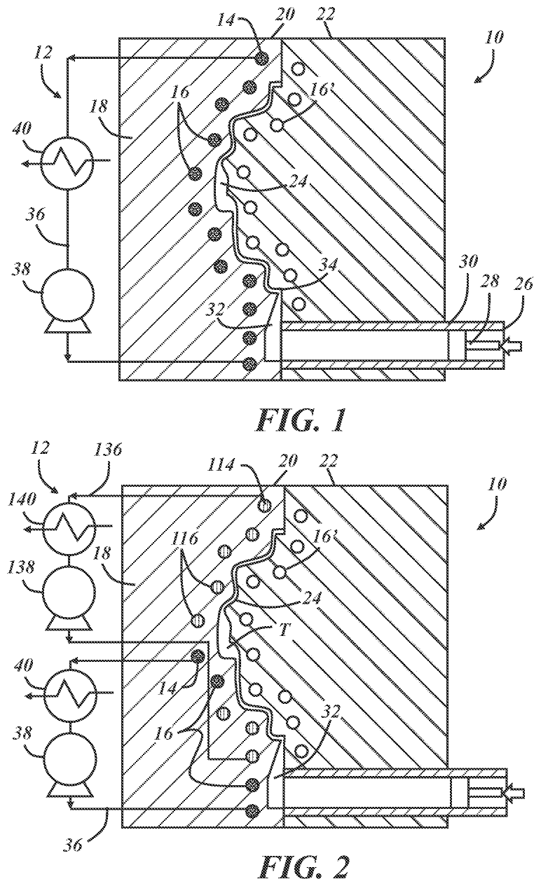

With reference to FIG. 1, a molding tool 10 can be equipped with a high-performance cooling system 12 in which a coolant 14 flows along one or more fluid channels 16 formed within a body 18 of the molding tool. The coolant 14 may be a high-performance coolant, meaning that it has one or more characteristics superior to that of conventional coolants. For example, the coolant 14 may have a relatively high thermal conductivity, specific heat capacity, volumetric heat capacity or boiling point and/or a relatively low viscosity. In various embodiments discussed further below, the coolant 14 comprises a metal to enhance its performance as a coolant.

The molding tool 10 of FIG. 1 is a die-casting tool and is illustrated in a closed condition in which first and second mold portions 20, 22 are pressed against each other in the horizontal direction to define a mold cavity 24 therebetween. Molten molding material is introduced into the cavity 24 by an injection system 26 that includes a piston 28 and a sleeve 30. Molten material is first transferred to the sleeve 30 from an external source, and the piston 28 then forces the material along a runner 32 and into the cavity 24 through a gate 34. The gate 34 is at an edge or other boundary of the cavity 24, which defines the shape of the molded part. The runner 32 is a hollow portion of the closed molding tool 10 extending between the injection sleeve 30 and the gate 34. The runner 32 provides a flow path for the molten material from the injection system to the mold cavity 24 as well as a buffer volume to ensure the cavity is filled. With the mold cavity 24 as the reference frame, the sleeve 30 or the injection system 26 may be considered the source of molten material in this example.

After the molten material in the cavity 24 has solidified, the mold portions 20, 22 are moved away from each other, and the molded part can be removed from the tool 10. In this example, the first mold portion 20 is the moving or cavity half of the tool, and the second mold portion 22 is the stationary or core half of the tool. The moving half 20 may include an ejector plate and ejector pins to help push the solidified molding material off of the tool 10. The solidified material from the runner 32 may then be removed from the molded part. The thickest part of the runner, formed at the end of the sleeve 30, may be referred to as a “puck” in die casting processes due to its typically round and thick shape. The illustrated molding tool 10 is configured for use in cold-chamber high pressure die casting, but the disclosed cooling system 12 is applicable to hot-chamber die casting, low pressure casting, squeeze-casting, and other metal casting techniques. Exemplary molding materials include, but are not limited to zinc, aluminum, magnesium, brass, and metal alloys including those and/or other materials. The cooling system 12 may also be employed in molding processes for polymer-based materials (e.g., injection molding), ceramics, or composites.

The molding tool 10 is configured for installation and removal from a molding machine, which may include other unillustrated components such as a hydraulic press, injection system components, platens to removably mount the mold portions 20, 22 in the machine, a material feed system, and/or electronic control systems. Each mold portion 20, 22 includes a mold body 18, which is the solid part of the mold, and the fluid channels 16 are formed in the mold body. The mold body 18 is formed from a material such as tool steel that is able to hold its shape and withstand the temperature of the molten molding material and the associated clamping and molding pressures. Other channels or hollow regions may be formed in each mold body 18 to accommodate gas venting, ejector pins, sensors, or wiring, for example.

The cooling system 12 includes one or more cooling circuits 36. Each cooling circuit 36 is a closed-loop fluid flow path including one or more interconnected fluid channels 16 along which the coolant 14 flows in a flow direction under the power of a fluid pump 38. The cooling circuit 36 of FIG. 1 also includes a heat exchanger 40 configured to extract heat from and/or control the temperature of the coolant 14 along the circuit. In some cases a heater or heat exchanger may be included to heat the coolant contained in the circuit, particularly with coolants that must be maintained at a temperature above ambient while the molding machine is idle, for example.

In the accompanying figures, the cross-sectional views are taken along a plane perpendicular to the flow channels 16, and all flow channels of the same cooling circuit 36 are depicted with the same hatch pattern. In FIG. 1, all of the hatched or darkened fluid channels 16 are interconnected as part of the illustrated cooling circuit 36 such that, when the coolant 14 is flowing along any one of the fluid channels 16, it is flowing along all of them. It should be understood that additional fluid channels interconnecting the illustrated fluid channels are formed in the mold body 18 as part of the same cooling circuit 36 but are not visible in the figures. The fluid channels 16 can be interconnected in series such that the coolant 14 flows back and forth through the mold portion 20, in parallel such that the coolant 14 flows in the same direction through each of the individual fluid channels, or in some combination of series and parallel.

Fluid channels 16′ are formed in the body of the second mold portion 22 as well. While these fluid channels 16′ may be considered part of the same cooling system 12 of the molding tool 10, they are part of a separate and distinct cooling circuit, as indicated in the figures by the unhatched or omitted cross-section pattern. The discussion below is related to the portion of the cooling system 12 associated with the first mold portion 20 depicted in the figures but is equally applicable to the second mold portion 22 or other additional mold portions.

The illustrated cavity 24 is configured to mold a generally dish-shaped part, and the fluid channels 16 are arranged in a pattern that follows that shape—i.e., each fluid channel 16 is spaced about the same distance from the cavity and from adjacent fluid channels. The primary function of the cooling system 12 is to extract heat from the material injected into the cavity 24 to first solidify the molten material and then further cool the solidified material until it can be removed from the tool 10. Though there are some exceptions, faster cooling is generally preferred over slower cooling, particularly in manufacturing operations where cycle time affects part cost. To the extent other problems are not created, the fluid channels 16 may thus be formed as close as possible to the cavity 24 and to each other. Other measures that can be employed to increase the rate of cooling of the molded material include decreasing the temperature of the coolant and/or increasing the flow rate of the coolant through the cooling circuit. But there are practical limitations to each of these measures.

Another cooling rate limitation is the intrinsic properties of the coolant 14. Water has long been a coolant of choice in the vast majority of cooling applications, including die casting and other molding operations, due mainly to its unique combination of a very low cost and a very high specific heat capacity. The specific heat capacity of water is among the highest of known substances, meaning that it can absorb relatively large amounts of thermal energy while its own temperature increase is relatively low. Additionally, water is liquid in a useful temperature range, non-toxic, and relatively easy to pump. But water has its own practical limitations. For example, water boils at 100° C., at which point its cooling capacity is diminished and pressure limits of the cooling circuit can be exceeded. This is particularly problematic with higher temperature casting materials, from which greater quantities of thermal energy must be extracted in the casting process. Also, in many casting operations, the molding surface must be kept above 100° C. to prevent the molten material from solidifying too fast before the cavity is filled.

Various oils have been used as the coolant in die casting operations to avoid the problems associated with water at such high process temperatures. But oils have only about half of the specific heat capacity of water and have a viscosity anywhere from 50 to 1000 times higher than water, making it difficult to pump and requiring much larger pumps that use more energy to move the fluid through a cooling circuit. Two additional and often overlooked properties, the volumetric heat capacity (Cᵥ) and the thermal conductivity (k), are also lower for oil than for water. The Cᵥ of oil is about 40% of that of water, and the thermal conductivity of oil is only about one-quarter that of water.

Volumetric heat capacity and thermal conductivity have now been identified as fluid characteristics useful to identify suitable coolants for use in the molding tool 10, particularly in applications in which tool surfaces along the mold cavity 24 are to be maintained at temperatures in excess of 100° C. The more commonly used specific heat capacity of a material is the amount of energy required per unit mass to change the temperature of the material by one degree and is expressed in SI units of J/kg-K. Volumetric heat capacity is the amount of energy required per unit volume to change the temperature of the material the same amount and is expressed in SI units of J/m³-K. Volumetric heat capacity accounts for the density of the material—i.e., if two materials have the same specific heat capacity, the higher density material has the higher volumetric heat capacity. For a given molding tool with fluid channels formed in the mold body, Cᵥ is a more appropriate material property to consider, since it is the size of the fluid channels that is a fixed quantity—not the mass of the coolant contained in the fluid channels. In the case of oil as an alternative to water, not only is the specific heat capacity of oil lower than water by about 50%, the density of oil is also lower, thus further limiting the relative cooling capacity of the oil when flowing through similarly sized fluid channels.

Thermal conductivity (k) is expressed in SI units of W/m-K and indicates the rate of thermal energy transfer through a material at a given temperature differential across the material. This material property traditionally does not garner much attention from skilled artisans in forced-fluid cooling applications because such applications are generally categorized as convective cooling (i.e., forced convection). Among known liquids, water has a relatively high thermal conductivity—about four times that of oil, for example. However, the thermal conductivity of water is only about 1% of that of many types of steel, from which the mold body 18 of the mold tool 10 may be constructed. As such, conventional coolants may be considered as a sort of thermal bottleneck that limits the rate of cooling of the molding tool 10 and the part being molded. In other words, while water or other liquids may have a very large capacity for absorbing heat, this capacity means very little if the energy can only be conducted into the liquid at a low rate.

The high-performance coolant disclosed herein addresses this thermal bottleneck caused by traditional coolants. As used herein, a high-performance coolant is any fluid that has a thermal conductivity (k) higher than that of water and is capable of being pumped along the fluid channels of the molding tool. In some cases, the thermal conductivity of the high-performance coolant is at least twice that of water or at least an order of magnitude higher than that of water. Relative to an oil, the high-performance coolant may also have a lower viscosity and/or a higher volumetric heat capacity (Cᵥ). In some cases, the viscosity of the high-performance coolant is at least an order of magnitude lower than that of the oil. The high-performance coolant may also have a boiling point greater than both water and the oil. In some cases, the boiling point of the high-performance coolant is greater than 1000° C. While the high-performance coolant may have a specific heat capacity much lower than that of water (e.g., less than 10%), it may also have a density much higher than water (e.g., 2 to 10 times higher) to provide a favorable volumetric heat capacity relative to other non-aqueous coolants. According to one non-limiting example, the high-performance coolant has: a greater thermal conductivity than water, a lower viscosity than a traditional oil coolant, a higher volumetric heat capacity (Cᵥ) than the traditional oil coolant, and a boiling point that is greater than that of water and the traditional oil coolant. As used herein, the traditional oil coolant is equivalent to an ISO Grade 32 mineral oil formulated for use in heat transfer applications.

Various embodiments of the coolant 14 include a metallic component that favorably influences both its thermal conductivity and its volumetric heat capacity. In one embodiment, the coolant includes a liquid phase metal or is a liquid phase metal. Metallic elements that are liquid at or near normal room temperatures include mercury (Hg), gallium (Ga), and cesium (Cs). Of these, gallium may be preferred due to its relatively low toxicity and/or low reactivity. While the specific heat capacity of gallium is less than 10% of that of water, the volumetric heat capacity is more than 50% that of water and higher than that of oil. Additionally, the thermal conductivity of liquid gallium is about 40 times that of water. As such, with liquid metal gallium as the coolant, even though the capacity of the coolant to absorb heat is lower than that of water, the rate of thermal conduction into the coolant 14 from the walls of the fluid channels 16 is higher by a much larger factor.

Other metallic elements may be suitable for use in the liquid phase as a coolant in metal die casting processes. For instance, several metallic elements are liquid at temperatures below 300° C. and therefore within a usable mold temperature range in aluminum or magnesium alloy die casting processes. Among these elements are indium (In) and tin (Sn), both of which have a thermal conductivity in the liquid phase that is even higher than gallium. While either of these elements could be used alone with a heater and temperature controller in a cooling circuit to maintain the metal in the liquid phase, they can alternatively be alloyed with gallium. In certain proportions, Ga—In and Ga—In—Sn form eutectic alloys, which are homogeneous mixtures that have a melting point below that of all of their individual constituent elements. Gallium and indium have a eutectic point at about 85% Ga and 15% In, at which composition the alloy melts at about 15° C. Other ratios of Ga and In remain eutectic with up to about 15% tin, where the melting point is even lower, at about 11° C. Ga—In—Sn alloys have been produced with other constituents that further reduce the melting point below 0° C. The thermal conductivity of such alloys may be lower than the constituent elements, but still may be about 25-30 times that of water.

Other metal alloys that may be suitable for use as a high-performance coolant include alloys comprising two or more of gallium (Ga), indium (In), tin (Sn), bismuth (Bi), lead (Pb), and cadmium (Cd). Examples include alloys in which bismuth is the main constituent, such as an alloy comprising 40-50% Bi, 15-40% Pb, and 10-15% Sn. Bi-based alloys may optionally include up to 10% Cd and/or up to 20% In. Various combinations of these metallic elements can form eutectic alloys and/or have a melting point of less than 100° C.

Liquid phase metals also have a relatively low viscosity, making them suitable for pumping with conventional pumps and through fluid channels sized for water flow. The viscosity of gallium and the above-mentioned Ga-alloys, for example, is only about twice that of water, while it is orders of magnitude lower than most oils. Further, due to their relatively high electrical conductivity, liquid phase metals may be pumped using electromagnetic pumps which can be more efficient than pumps that rely on mechanical displacement of the liquid.

The coolant 14 may be something other than a liquid phase metal. For instance, the coolant 14 may include a high thermal conductivity material suspended in micro- or nanoparticle form in a liquid such as water or oil to increase the thermal conductivity of the liquid while maintaining desirable properties of the liquid such as heat capacity. Such additives may be capable of providing the coolant with a thermal conductivity of 1.0 W/m-K or higher even if the liquid component has a thermal conductivity below 1.0 W/m-K. Preferably, the thermal conductivity of the liquid coolant is greater than 5.0 W/m-K or greater than 10 W/m-K.

With reference to FIG. 2, embodiments of the cooling system 12 may include a first cooling circuit 36 and a separate and distinct second cooling circuit 136 with each cooling circuit containing a different coolant 14, 114. Each cooling circuit includes a dedicated pump 38, 138 and heat exchanger 40, 140. At least one of the coolants 14, 114 is a high-performance coolant as described above. For example, the first coolant 14 may include a liquid phase metal and/or have a thermal conductivity of 1.0 W/m-K or higher. The second coolant 114 may also be a high-performance coolant having a different formulation, or it may be water, oil, or some other coolant. This configuration offers certain additional advantages, such as the ability to target specific portions of the tool for enhanced cooling. In some cases, the performance of the coolant may be too high to be useful in all areas of the tool and may pose the risk of solidifying the molten material injected into the mold before the mold is completely filled and/or before the microstructure of the molten material has had time to assume a desired form (e.g., crystallinity, solid solution phases, etc.).

In the illustrated example, the first cooling circuit 36 includes the fluid channels 16 that are closest to the runner 32 and, in particular, closest to the thickest portion of the runner that forms the above-described “puck.” The first cooling circuit 36 also includes the fluid channels 16 that are closest to a thickest portion (T) of the cavity 24. The remainder of the fluid channels 116 in the first mold portion 20 of the tool 10 are part of the second cooling circuit 136, which contains a more conventional, less aggressive coolant capable of sufficiently cooling the portions of the cavity 24 that define the nominal wall thickness of the molded part. An example of the thickest portion (T) of the cavity 24 is the location of an oil drain plug in a vehicle differential housing, which must be formed thicker than finally necessary so that the casting can later be drilled and threaded to receive the drain plug.

Even though most of the fluid channels 116 in this example may contain a conventional coolant 114, the cycle time may still be reduced via selective use of the high-performance coolant 14 because the thickest portion (T) of the cavity 24 and/or the runner 32 would otherwise be the limiting factor for the cycle time. The use of two distinct cooling circuits 36, 136 allows the cooling time among different portions of the cavity 24 to be somewhat equalized and cooled in the same amount of time. This configuration also keeps the quantity of the high-performance coolant in the cooling circuit 36 to a minimum, which helps mitigate the relatively high cost of the coolant compared to conventional coolants like water. In another example, an embodiment of the high-performance coolant 14 is routed through fluid channels located proximate or nearest the sleeve 30 and/or plunger 28 of the injection system. These fluid channels could be part of the first cooling circuit 36 or part of a separate additional cooling circuit.

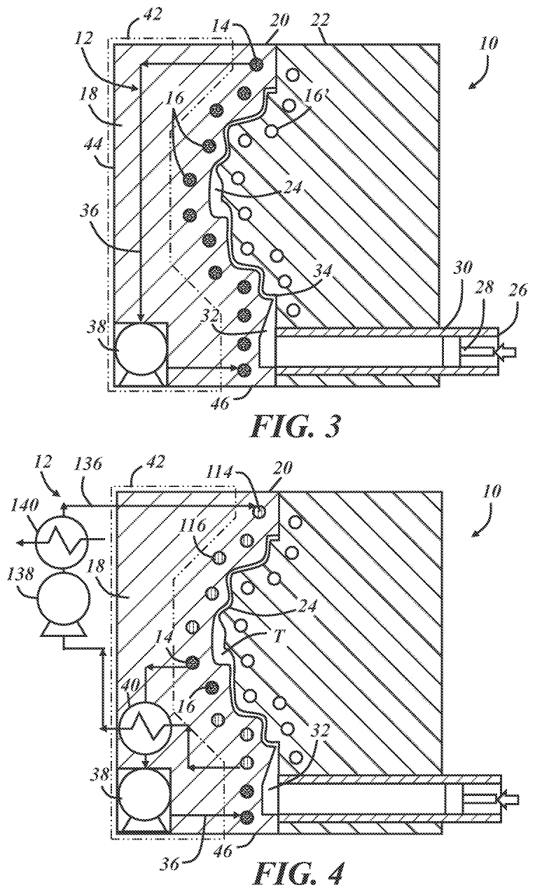

In the example of FIG. 3, the cooling circuit 36 is a self-contained cooling circuit. This means that the pump 38, the fluid channels 16, and the coolant 14 are integrated with the body 18 of one of the mold portions 20 so that the cooling circuit 36 remains part of the molding tool 10 when the molding tool is installed in a molding machine and when the molding tool is uninstalled from the molding machine. The cooling circuit 36 thus remains a closed system for the coolant 14 without repeated connection or disconnection of coolant lines as there are in conventional systems when a common molding machine is used for multiple different molding tools. Such a configuration may be beneficial with the above-described high-performance coolant, which may be more expensive than conventional coolants and/or require special handling or clean-up procedures when outside the tool. The high-performance coolant is not limited to a self-contained cooling circuit, however.

In this example, the coolant 14 is routed through a heat sink region 42 of the mold portion 20, spaced from the mold cavity 24 and near a mounting side 44 of the mold portion. The only other function of this massive part of the molding tool 10 is to provide a flat mounting side 44 for mounting the molding tool in the molding machine, such as to a platen of the molding machine. The illustrated configuration takes advantage of this otherwise wasted and large amount of thermal mass by using it to extract heat from the high-performance coolant 14 after it flows through the fluid channels 16 situated near the mold cavity 24 in a heat extraction zone 46, which is defined between the heat sink region 42 and the surface of the mold portion 20 facing the other mold portion 22. This allows more of the total mass of the mold body 20 to absorb and dissipate heat from the mold cavity 24 rather than just the portion of the tool in the heat extraction zone 46. Optionally, a second coolant may be routed through the heat sink region 42 to cool the mold body material in that region so that it acts as a heat exchanger, or a conventional heat exchanger can be included as part of the self-contained cooling circuit 36.

The embodiment of FIG. 4 combines certain features of FIGS. 2 and 3, with a first cooling circuit 36 that is self-contained and a distinct second cooling circuit 136. In this case, a first pump 38 and heat exchanger 40 are integrated with the first mold portion 20, staying with the molding tool 10 when installed and when uninstalled from the molding machine with the closed loop of high-performance coolant 14 remaining closed. The fluid channels 16 that are closest to the runner 32 and to the thickest portion (T) of the cavity 24 are part of the self-contained cooling circuit 36. The remaining fluid channels 116 in the first mold portion 20 are part of the second cooling circuit 136, along which a different second coolant 114 flows under the influence of the second pump 138 and through the external heat exchanger 140. It should be understood that while the external pump 138 and heat exchanger 140 are schematically illustrated as being dedicated to the molding tool 10, they may be provided by a central chilling system and/or water tower or other coolant source shared by other molding machines and molding tools.

An additional feature of the configuration of FIG. 4 is that the second coolant 114 is used as a heat exchange medium in the first heat exchanger 40. Starting at the second pump 138, the second coolant 114 flows through the second heat exchanger 140, where thermal energy is removed from the coolant. The coolant 114 then flows along the plurality of fluid channels 116 in the heat extraction zone 46 of the mold portion 20 situated adjacent the mold cavity 24. After extracting heat from the mold cavity 24, the second coolant 114 flows through the first heat exchanger 40, where it can extract additional heat from the first coolant 14, which may be at a higher temperature than the second coolant after each coolant has flowed along the heat extraction zone 46. Alternatively, or additionally, the first coolant 14 can be routed through the heat sink region 42 of the first mold portion 20 as in FIG. 3, or the first cooling circuit 36 may include another heat exchanger with a cooler heat exchange medium flowing therethrough. The overall effect of either configuration is to more quickly pull heat away from the mold cavity 24 and transfer it to a cooler part of the molding tool 10 to provide more time to rid the molding tool 10 of excess heat while keeping cycle times low.

As noted above, the sleeve 30 of the injection system is another region along which a dedicated high-performance cooling circuit is useful. This portion of the tool 10 contains the molten molding material while it is at its highest temperature, and accelerated cooling of the sleeve 30, particularly at the end nearest the runner 32, is useful to help solidify the puck, which can be the last portion of injected material to solidify. The sleeve 30 may be located or configured differently than in the figures, and some or all of the sleeve may be located outside the mold body. In one embodiment, a cooling circuit including fluid channels along which the high-performance coolant flows is a self-contained part of the molding machine in which the molding tool is installed for use such that the pump, fluid channels, and coolant are integrated with and remain with the molding machine when the molding tool is uninstalled from the molding machine.

It is to be understood that the foregoing description is not a definition of the invention but is a description of one or more exemplary illustrations of the invention. The invention is not limited to the particular example(s) disclosed herein, but rather is defined solely by the claims below. Furthermore, the statements contained in the foregoing description relate to particular exemplary illustrations and are not to be construed as limitations on the scope of the invention or on the definition of terms used in the claims, except where a term or phrase is expressly defined above. Various other examples and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A molding tool comprising a cooling system having a fluid channel formed within a body of the molding tool, wherein the cooling system is arranged so that a coolant that comprises a liquid phase metal flows along the fluid channel.

2. The molding tool of claim 1, wherein the liquid phase metal includes a eutectic alloy comprising a plurality of different metallic elements.

3. The molding tool of claim 1, wherein the liquid phase metal comprises gallium.

4. The molding tool of claim 1, further comprising:
first and second tool portions that at least partly define a mold cavity when the molding tool is in a closed condition; and
a runner that interconnects the mold cavity with a molding material source when the molding tool is installed in a molding machine,
wherein the fluid channel is one of a plurality of fluid channels formed within the body of the molding tool and is the closest of the fluid channels to the runner.

5. The molding tool of claim 1, wherein the fluid channel is part of a cooling circuit along which the coolant that comprises the liquid phase metal flows through a heat extraction zone and a heat sink region, the coolant extracts heat from a molding material in a mold cavity of the molding tool in the heat extraction zone and heat is transferred from the coolant to the body of the molding tool in the heat sink region.

6. The molding tool of claim 1, further comprising a self-contained cooling circuit comprising a pump, the fluid channel, and the coolant that comprises the liquid phase metal, the cooling circuit being integrated with the body of the molding tool so that the cooling circuit remains part of the molding tool when the molding tool is installed in a molding machine and when the molding tool is uninstalled from the molding machine.

7. The molding tool of claim 6, further comprising an additional cooling circuit distinct from the self-contained cooling circuit, wherein the additional cooling circuit contains a coolant different from the coolant of the self-contained cooling circuit that comprises the liquid phase metal.

8. The molding tool of claim 6, further comprising:
first and second tool portions that at least partly define a mold cavity when the molding tool is in a closed condition; and
a runner that interconnects the mold cavity with a molding material source when the molding tool is installed in the molding machine,
wherein the fluid channel is one of a plurality of fluid channels of the self-contained cooling circuit and is the closest of the fluid channels to the runner.

9. The molding tool of claim 6, wherein the coolant that comprises the liquid phase metal flows along the self-contained cooling circuit through a heat extraction zone and a heat sink region, the coolant extracts heat from a molding material in a mold cavity of the molding tool in the heat extraction zone and heat is transferred from the coolant to the body of the molding tool in the heat sink region.

10. A molding tool comprising a cooling system having a first cooling circuit and a second cooling circuit distinct from the first cooling circuit, wherein each cooling circuit contains a different coolant and at least one of the coolants has a thermal conductivity (k) of 1.0 W/m-K or greater.

11. The molding tool of claim 10, wherein at least one of the different coolants includes a eutectic alloy comprising a plurality of different metallic elements.

12. The molding tool of claim 10, wherein at least one of the different coolants comprises gallium.

13. The molding tool of claim 10, further comprising:
first and second tool portions that at least partly define a mold cavity when the molding tool is in a closed condition; and
a runner that interconnects the mold cavity with a molding material source when the molding tool is installed in a molding machine,
wherein the coolant contained by the cooling circuit closest to the runner has the highest thermal conductivity (k) of the different coolants.

14. The molding tool of claim 10, wherein a first coolant flows along the first cooling circuit and extracts heat from a molding material in a mold cavity of the molding tool at a first portion of the first cooling circuit, and
a second coolant flows along the second cooling circuit and extracts heat from the first coolant at a second portion of the first cooling circuit formed within a body of the molding tool.

15. The molding tool of claim 10, wherein at least one of the cooling circuits is a self-contained cooling circuit comprising a pump, a fluid channel, and a liquid phase metal coolant, the self-contained cooling circuit being integrated with a body of the molding tool and remaining part of the molding tool when the molding tool is installed in a molding machine and when the molding tool is uninstalled from the molding machine.

16. The molding machine of claim 15, wherein the fluid channel is located along an injection system sleeve and/or a plunger from which molten molding material is injected into a cavity of the molding tool when installed in the molding machine.

17. A method of using a molding tool comprising a cooling system having a fluid channel formed within a body of the molding tool, the method comprising the steps of:
providing a coolant in the fluid channel, wherein the coolant comprises a liquid phase metal;
causing the coolant to flow along the fluid channel;
extracting heat with the coolant from a molding material in a mold cavity of the molding tool in a heat extraction zone; and
transferring heat from the coolant to the body of the molding tool in a heat sink region.
